(19) United States
(12) Patent Application Publication
(10) Pub. No.: US 2025/0379666 A1
(43) Pub. Date: Dec. 11, 2025

(54) MULTIPLE CODEWORD SIMULTANEOUS MULTI-PANEL TRANSMISSION

(71) Applicant: InterDigital Patent Holdings, Inc., Wilmington, DE (US)

(72) Inventors: Ahmet Serdar Tan, London (GB); Arman Shojaeifard, London (GB); Javier Lorca Hernando, Madrid (ES); Kyle Jung-Lin Pan, Saint James, NY (US); Patrick Svedman, Stockholm (SE); Allan Yingming Tsai, Boonton, NJ (US)

(73) Assignee: InterDigital Patent Holdings, Inc., Wilmington, DE (US)

(21) Appl. No.: 18/877,119

(22) PCT Filed: Jul. 7, 2023
(86) PCT No.: PCT/US2023/027112

§ 371 Date: Dec. 19, 2024

(51) Int. Cl. H04B 17/309; H04L 1/00; H04L 5/00

(52) U.S. Cl. CPC H04B 17/309; H04L 1/0003; H04L 1/0009; H04L 5/0055

(57) ABSTRACT

A method performed by a base station (BS) within a radio access network (RAN), the method comprising: receiving uplink (UL) reference signals (RSS) sent from each of a plurality of transmission/reception points (TRPs), a respective UL RSs received at each of a plurality of TRPs from each of a plurality of panels, determining a channel measuring indicator (CQI) for each of the received UL RSs, selecting a respective panel from the plurality of panels for each of the plurality of TRPs based on the determined CQI for each of the received UL RSs, and transmitting a codeword and the determined respective panel for each of the plurality of TRPs, the codeword for each of the plurality of the TRPs having a priority based on the determined CQI for each of the received UL RSs.

### CROSS-REFERENCE TO RELATED APPLICATIONS

This application claims the benefit of U.S. Provisional Application No. 63/388,045, filed on Jul. 11, 2022, the entire contents of which are incorporated herein by reference.

### BACKGROUND

The present disclosure relates generally to panel transmission. Specifically, the present disclosure relates to simultaneous multi-panel transmission with multiple codewords (CW).

Mobile communication systems have been designed to provide voice services while ensuring user activity. However, the coverage of mobile communication services has expanded to data services in addition to voice services. The rapid growth of traffic may result in a lack of resources and a user demand for high-speed services that require advanced mobile communication systems. The requirements of the next generation mobile communication system may include support for a significant increase in the transmission speed and data traffic of each user, a significant increase in the number of connected devices, a need for low end-to-end delay times, and high energy efficiency.

There is a need to develop an improved 5G or pre-5G communication system that satisfies these requirements. Consequently, the 5G or pre-5G communication system may be called ‘Beyond 4G Network’ or ‘Post LTE System.’ For higher data rates, 5G communication systems may be implemented in higher frequency (mm-Wave) bands, such as 60 GHz bands. 5G communication systems may implement beamforming, massive multiple-input multiple-output (MIMO), full dimensional MIMO (FD-MIMO), array antenna, analog beamforming, and large scale antenna techniques to help decrease propagation loss of radio waves and increase transmission distances. Further development in 5G communication systems may include advanced small cells, cloud Radio Access Networks (RANs), ultra-dense networks, device-to-device (D2D) communication, wireless backhaul, moving network, cooperative communication, coordinated multi-points (COMP), and reception-end interference cancellation. 5G communication systems may implement hybrid FSK and QAM Modulation (FQAM) and sliding window superposition coding (SWSC) as an advanced coding modulation (ACM). Moreover, 5G communication systems may further implement filter bank multi carrier (FBMC), non-orthogonal multiple access (NOMA), and sparse code multiple access (SCMA) as advanced access technologies have been developed.

### SUMMARY

Methods, systems, and apparatuses are provided to receive retransmissions of transport blocks (TBs) (e.g., codewords) with different priorities over different panels and/or transmit/receive points (TRPs) than originally scheduled.

A wireless transmit/receive unit may comprise a processor. The processor may be configured to receive configuration information indicating one or more rules for determining a panel out of a plurality of panels that is to be used for reception of a retransmitted codeword. The processor may be further configured to measure downlink (DL) reference signals (RSs) sent from each of a plurality of transmission/reception points (TRPs), wherein a respective DL RSs is received from each of the plurality of TRPs via a panel of the plurality of panels. The processor may be further configured to select a respective TRP for each of the plurality of panels based on the measured DL RSs. The processor may be further configured to send feedback indicating the respective TRP selected for each of the plurality of panels, wherein channel quality indication (CQI) feedback is provided for each combination of the plurality of TRPs and the plurality of panels. The processor may be further configured to receive at least a first codeword from a first TRP of the plurality of TRPs via a first panel of the plurality of panels and a second codeword from a second TRP of the plurality of TRPs via a second panel of the plurality of panels. The processor may be further configured to determine that a retransmission of the first codeword from the first TRP is to be received via the second panel based on the first codeword being higher priority than the second codeword and based on the one or more rules indicated by the configuration information. The processor may be further configured to receive the retransmission of the first codeword from the first TRP via the second panel.

The processor may be further configured to receive information indicating an association between each of the plurality of TRPs and each of the plurality of panels, a priority of each TRP to panel association, a modulation and coding scheme (MCS) for each TRP to panel association, or a resource to be used for each TRP to panel association.

The one or more rules may indicate: whether the WTRU is configured for downlink control information (DCI)-free retransmission or retransmission with DCI, whether or not the WTRU should transmit acknowledgment (ACK) messages for received codewords, or a number of CQI reports that are configured per panel of the plurality of panels.

The feedback may indicate that a CQI associated with a combination of the first TRP and the first panel is stronger than any other combination of the plurality of TRPs and the plurality of panels.

The processor may be further configured to determine that the retransmission of the first codeword is to be received from the first TRP via the second panel based on a CQI associated with the combination of the second TRP and the second panel being stronger than any other combination of the plurality of TRPs and the plurality of panels except for the association of the first TRP and the first panel.

The processor may be further configured to review an indication that the retransmission of the first codeword is to be received from the first TRP via the second panel.

The processor may be further configured to detect that a failure occurred when attempting to receive the first codeword from the first TRP via the first panel and send a negative acknowledgement (NACK) in response to the failure prior to the determination that the retransmission of the first codeword from the first TRP is to be received via the second panel.

The processor may be further configured to detect that a failure occurred when attempting to receive the first codeword from the first TRP via the first panel, send an updated CQI feedback for each combination of the plurality of TRPs and the plurality of panels, and receive information indicating an updated associated between each of the plurality of TRPs and each of the plurality of panels.

The processor may be further configured to determine that the CQI feedback provided for each TRP and associated panel satisfies a block error rate (BLER) threshold.

A method may be performed by a base station (BS) within a radio access network (RAN). The method may comprise receiving uplink (UL) reference signals (RSs) sent from each of a plurality of transmission/reception points (TRPs), a respective UL RSs received at each of a plurality of TRPs from each of a plurality of panels. The method may further comprise determining a channel measuring indicator (CQI) for each of the received UL RSs. The method may further comprise selecting a respective panel from the plurality of panels for each of the plurality of TRPs based on the determined CQI for each of the received UL RSs. The method may further comprise transmitting a codeword and the determined respective panel for each of the plurality of TRPs, the codeword for each of the plurality of the TRPs having a priority based on the determined CQI for each of the received UL RSs.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example multiple transmission/reception point (mTRP) uplink (UL) scheme.

FIG. 3 is an example of a modulation and coding scheme (MCS) index table for a physical downlink channel (PDSCH).

FIG. 4 is an example of a 4-bit bitwidth channel quality indicator (CQI) table.

FIG. 5 is a diagram illustrating an example panel to transmission/reception point (TRP) association involving 4 panels and 3 TRPs.

FIG. 6 is a diagram illustrating an example panel to TRP association involving 4 panels and 5 TRPs.

FIG. 7 is a diagram illustrating an example panel to TRP associations for a single CW for 4 panels and 3 TRPs.

FIG. 8 is a diagram illustrating a method for obtaining a single CQI value for a single CW for all panels.

FIG. 9 is a procedure diagram illustrating an example panel to TRP association for a downlink (DL) channel.

FIG. 10 is a procedure diagram illustrating an example panel to TRP association for an uplink (UL) channel.

FIG. 11 is a flowchart diagram illustrating an example process for bitwidth reduction based on computed CQI/MCS values.

FIG. 12 is a procedure diagram illustrating an example panel to TRP association for a DL channel based on priorities.

FIG. 13 is a procedure diagram illustrating an example panel to TRP association for a UL channel based on priorities.

FIG. 14 is a table illustrating example assignments of priorities to transport blocks (TBs).

FIG. 15 is a table illustrating example assignments of MCS indices to CWs.

FIG. 16 is a table illustrating example associations of TBs to CWs.

FIG. 17 is a flowchart diagram illustrating an example process for retransmission on different panels.

### DETAILED DESCRIPTION

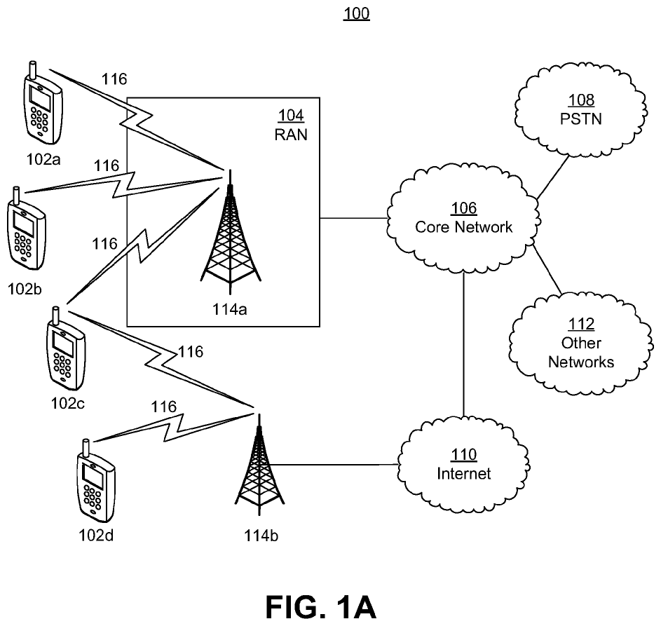

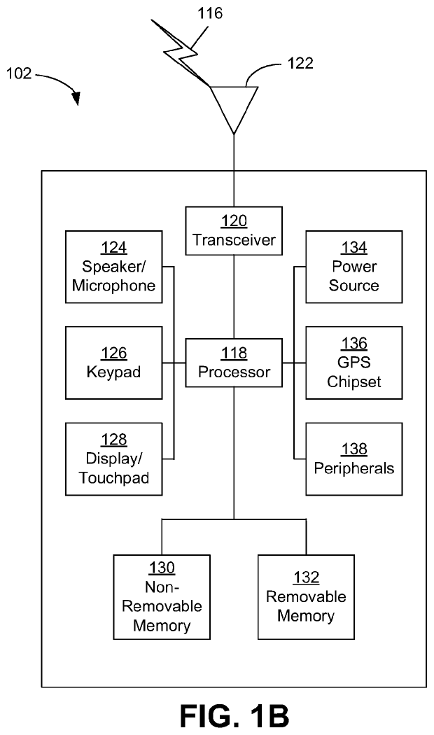

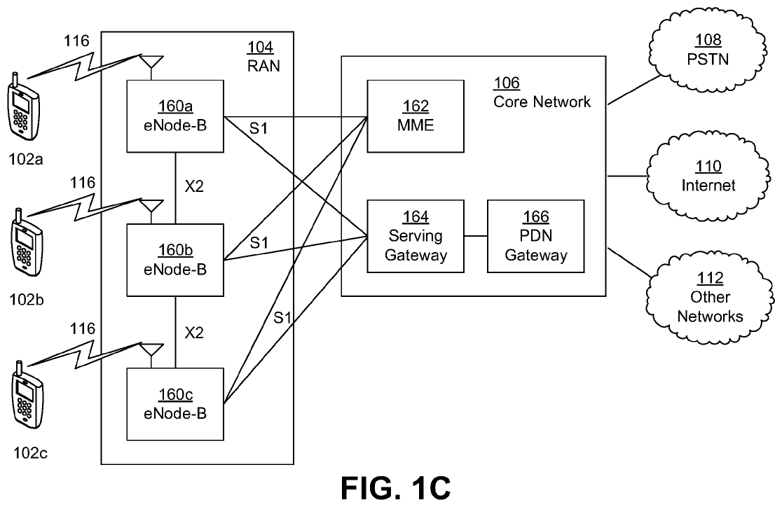

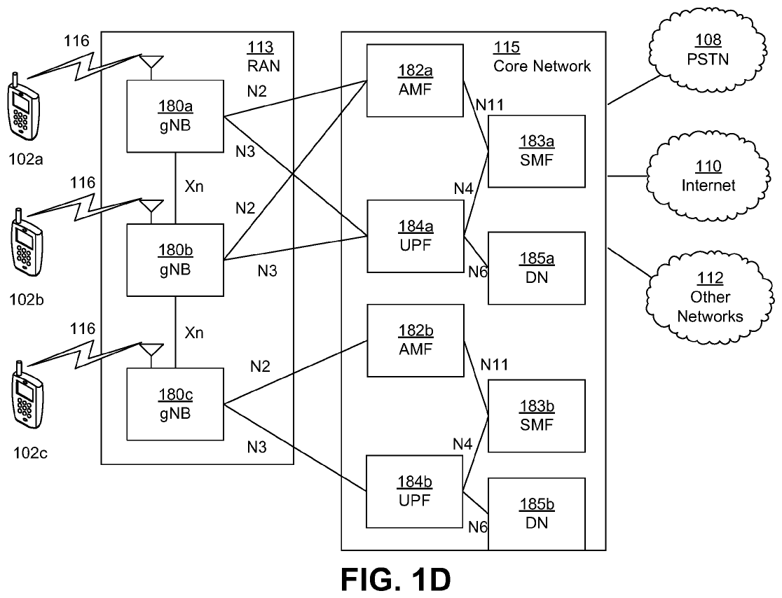

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or an “STA,” may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed, or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance, using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b. 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP), and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality, and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, and 160c, though it will be appreciated that the RAN 104 may include any number of eNode-Bs while remaining consistent with an embodiment. The eNode-Bs 160a, 160b, and 160c may each include one or more transceivers for communicating with the WTRUs 102a, 102b, 102c over the air interface 116. In one embodiment, the eNode-Bs 160a, 160b, and 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, and 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attachment of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, and 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c, and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c, and traditional land-line communications devices. For example, the CN 106 may include or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it may be contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP, and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operation, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, carrier sense multiple access with collision avoidance (CSMA/CA) may be implemented, for example, in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHz and/or 80 MHz channels may be formed by combining contiguous 20 MHz channels. A 160 MHz channel may be formed by combining 8 contiguous 20 MHz channels or by combining two non-contiguous 80 MHZ channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped onto the two 80 MHz channels, and the data may be transmitted by a transmitting STA. At the receiver of the receiving STA, the above-described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n and 802.11ac. 802.11af supports 5 MHz, 10 MHZ, and 20 MHz bandwidths in the TV White Space (TVWS) spectrum, and 802.11ah supports 1 MHz, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities, including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel that may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHz, and/or other channel bandwidth operating modes. Carrier sensing and/or Network Allocation Vector (NAV) settings may depend on the status of the primary channel. If the primary channel is busy, for example, due to an STA (which supports only a 1 MHz operating mode), transmitting to the AP, the entire available frequency bands may be considered busy even though a majority of the frequency bands remain idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHZ depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, and 180c, though it will be appreciated that the RAN 113 may include any number of gNBs while remaining consistent with an embodiment. The gNBs 180a, 180b, and 180c may each include one or more transceivers for communicating with the WTRUs 102a, 102b, 102c over the air interface 116. In one embodiment, the gNBs 180a, 180b, and 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, and 180c may implement carrier aggregation technology. For example, the gNB 180a may transmit multiple component carriers to the WTRU 102a (not shown). A subset of these component carriers may be on the unlicensed spectrum, while the remaining component carriers may be on the licensed spectrum. In an embodiment, the gNBs 180a, 180b, and 180c may implement Coordinated Multi-Point (COMP) technology. For example, WTRU 102a may receive coordinated transmissions from gNB 180a and gNB 180b (and/or gNB 180c).

The WTRUs 102a. 102b, 102c may communicate with gNBs 180a, 180b, and 180c using transmissions associated with scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, and 180c using subframe or transmission time intervals (TTIs) of various or scalable lengths (e.g., containing a varying number of OFDM symbols and/or lasting varying lengths of absolute time).

The gNBs 180a, 180b, and 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, and 180c without also accessing other RANs (e.g., such as eNode-Bs 160a, 160b, 160c). In the standalone configuration, WTRUs 102a, 102b, 102c may utilize one or more of gNBs 180a, 180b, and 180c as a mobility anchor point. In the standalone configuration, WTRUs 102a, 102b, 102c may communicate with gNBs 180a, 180b, and 180c using signals in an unlicensed band. In a non-standalone configuration WTRUs 102a, 102b, 102c may communicate with/connect to gNBs 180a, 180b, and 180c while also communicating with/connecting to another RAN such as eNode-Bs 160a, 160b, and 160c. For example, WTRUs 102a, 102b, 102c may implement DC principles to communicate with one or more gNBs 180a, 180b, 180c, and one or more eNode-Bs 160a, 160b, 160c substantially simultaneously. In the non-standalone configuration, eNode-Bs 160a, 160b. 160c may serve as a mobility anchor for WTRUs 102a, 102b, 102c, and gNBs 180a, 180b, and 180c may provide additional coverage and/or throughput for servicing WTRUs 102a, 102b, 102c.

Each of the gNBs 180a, 180b, and 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a. 184b, routing of control plane information towards Access and Mobility Management Function (AMF) 182a, 182b and the like. As shown in FIG. 1D, the gNBs 180a, 180b, and 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements is depicted as part of the CN 115, it will be appreciated that any of these elements may be owned and/or operated by an entity other than the CN operator.

The AMF 182a, 182b may be connected to one or more of the gNBs 180a, 180b. 180c in the RAN 113 via an N2 interface and may serve as a control node. For example, the AMF 182a and 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases, such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP addresses, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may transmit or receive a physical channel or reference signal according to at least one spatial domain filter. The term “beam” may refer to a spatial domain filter. The WTRU may transmit a physical channel or signal using the same spatial domain filter as the spatial domain filter used for receiving an RS (such as CSI-RS) or a SS block.

The WTRU may receive a first downlink channel or signal according to the same spatial domain filter or spatial reception parameter as a second downlink channel or signal. For example, such an association may exist between a physical channel such as PDCCH or PDSCH and its respective DM-RS. At least when the first and second signals are reference signals, such an association may exist when the WTRU is configured with a quasi-colocation (QCL) assumption between corresponding antenna ports. Such associations may be configured as a transmission configuration indicator (TCI) state. A WTRU may be indicated as an association between a CSI-RS or SS block and a DM-RS by an index to a set of TCI states configured by RRC and/or signaled by MAC CE. Such indications may also be referred to as a “beam indication.”

A unified TCI (e.g., a common TCI, a common beam, a common RS, etc.) may refer to a beam/RS to be (simultaneously) used for multiple physical channels/signals. The term “TCI” may at least comprise a TCI state that includes at least one source RS to provide a reference (e.g., UE assumption) for determining QCL and/or spatial filter. A Unified TCI state instance may be equivalent or identified to a Coreset Pool identity (e.g., CORESETPoolIndex, a TRP indicator, and/or the like).

A TRP (e.g., transmission and reception point) may be interchangeably used with one or more of TP (transmission point), RP (reception point), RRH (radio remote head), DA (distributed antenna), BS (base station), a sector (of a BS), and a cell (e.g., a geographical cell area served by a BS). A WTRU may be configured with (or may receive configuration of) one or more TRPs (i.e., multi TRP, mTRP) to which the WTRU may transmit and/or from which the WTRU may receive. The WTRU may be configured with one or more TRPs for one or more cells. A cell may be a serving cell or a secondary cell.

A WTRU may be configured with at least one RS for the purpose of channel measurement. This RS may be denoted as a Channel Measurement Resource (CMR) and may comprise a CSI-RS, SSB, or another downlink RS transmitted from the TRP to a WTRU. A CMR may be configured or associated with a TCI state.

Multi-panel studies for multiple transmission and reception points (mTRP) have focused on panels and 2 TRPs. As an example, mTRP (2 TRPs) for uplink (UL) may be defined to increase reliability in a time division multiplexing (TDM) based repetition scheme. In such a configuration, the WTRU may use the same codeword (CW) for each physical uplink shared channel (PUSCH) on both TRP links.

A WRTU may support multiple codewords for panel to TRP links. For such a configuration, the WRTU may support one CW per panel as well as one CW for all panels. As an example, the WRTU may support one or more selected CWs between a base station (BS) and WTRU. In a scenario in which multiple codewords support a multi-panel to m TRP association, bitwidth reduction methods may be implemented to reduce the overhead of channel quality indicator (CQI) and modulation and coding Scheme (MCS) information exchanges between a BS and a WTRU.

The data flow between WTRU and BS may be subject to different priorities in a multiple codeword configuration. In scenarios where priorities are known to the BS and WTRU, methods may be implemented to enable priority aware transport blocks to perform codeword association for multi-panel to mTRP associations. In the multiple codeword configuration, multiple transmission and reception points (mTRP), multi-panel, modulation, and coding scheme (MCS) index, and channel state information (CSI) feedback may be present.

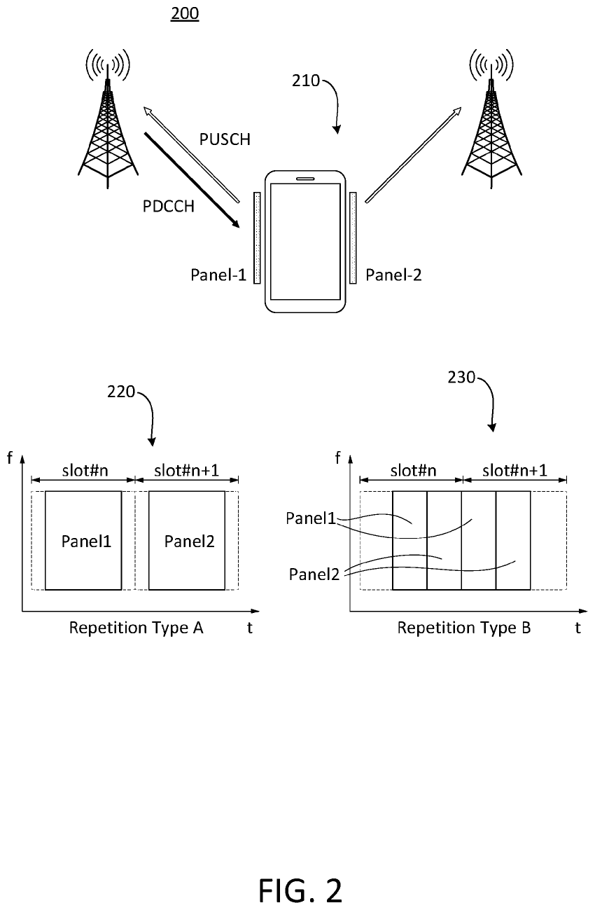

FIG. 2 is a diagram 200 illustrating an example multiple transmission and reception point (mTRP) uplink (UL) scheme. As shown in FIG. 2, mTRP methods may enable data transmission to and/or from a WTRU using different TRPs of a gNB. The mTRP methods may be used to increase the throughput of cell edge users, enhance data rates, improve system capacity, and/or as a means to improve link diversity gain for scenarios such as URLLC and high-speed trains, for example. The methods of the mTRP UL scheme may be limited to PUSCH repetition to improve reliability.

As shown in 210, PUSCH repetitions may be sent to 2 TRPs scheduled by one PDCCH (e.g., single DCI). As an example, two schemes for UL 2 TRP may be supported. As shown in 220, for example, a first scheme may be inter slot repetition (e.g., Repetition Type A). As shown in 230, for example, a second scheme may be intra slot repetition (e.g., Repetition Type B).

A WTRU may transmit PUSCH repetitions to mTRPs using different beams. To support 2 TRP UL beams from a WTRU, up to 2 SRS resource indicator (SRI) and/or 2 transmit precoder matrix indicator (TPMI) fields may be defined within a single downlink control information (DCI) field.

The WTRU may transmit TDM-based PUSCH repetitions. As an example, a BS may schedule UL transmissions with one PDCCH that may be unaware of the existence of any panels. As such, panels may be transparent to the BS, and it may be up to the WTRU to decide which panel to use. The WTRU may choose a panel based on CQI computations from both of the 2 TRPs. For example, each transmission instant panel may be activated by the WTRU per the TDM scheme. Mechanisms to handle simultaneous multi-panel WTRU transmissions may not be defined.

A channel coding rate may determine the number of output and input bits for the channel decoding process. As the channel coding rate increases, spectral efficiency may increase while protection against errors may decrease.

A modulation index may determine the number of bits per transmission symbol used. As the modulation index increases, spectral efficiency may increase while error protection decreases.

A modulation and coding scheme (MCS) index table may define the modulation order and channel coding rates that may jointly increase spectral efficiency. For example, a higher MCS index may be used as the channel quality increases.

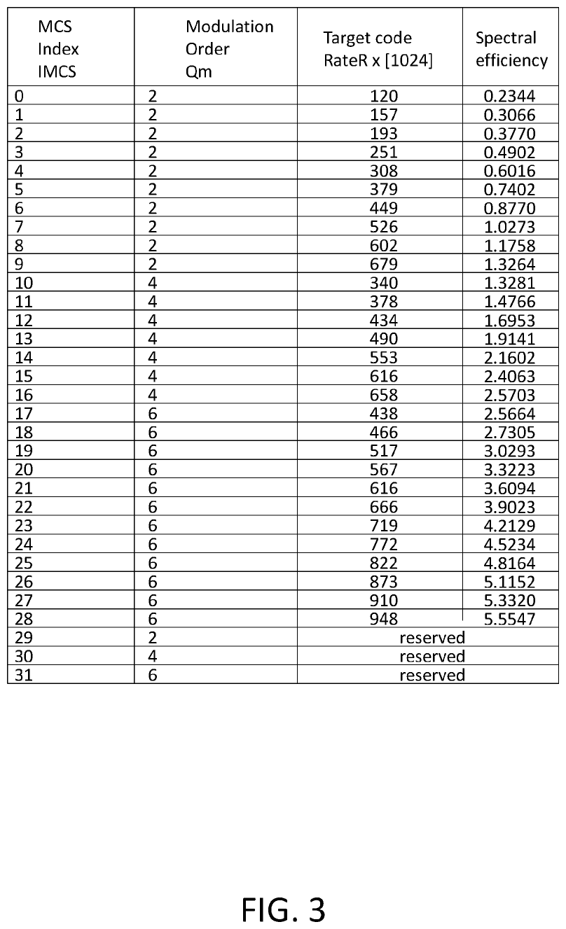

FIG. 3 is an example of an MCS index table for PDSCH. As shown in FIG. 3, the MCS index may be composed of 5 bits and may be indicated for one or more, or all, codewords to a WTRU via PDCCH. The codewords may be indicated for one, or both, of DL and UL. The MCS index may be transmitted to the WTRU by a gNB inside the DCI fields of the PDCCH. A maximum number of supported MCS indexes in the DCI may be two, corresponding to two codewords for DL transmissions. One CW for UL transmissions may be defined, and the maximum number of layers may be 4.

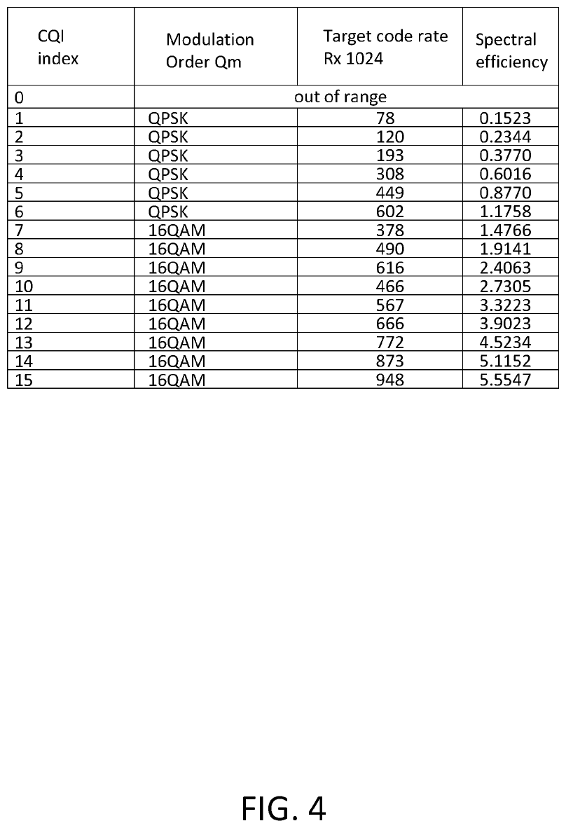

FIG. 4 is an example of a 4-bit bitwidth CQI table. CSI feedback from a WTRU may inform the gNB of parameters such as CQI, precoding matrix indicator (PMI), and/or rank indicator (RI). The CSI feedback may be sent in PUCCH or PUSCH in UCI, and each field of the CSI may occupy a different bitwidth.

As shown in FIG. 4, as a CQI index increases, the spectral efficiency may increase. As an example, the CQI values may range from 0 to 15, the CQI value indicating a maximum MCS value that may be suitable for the transmission that satisfies a certain block error rate.

The PMI may define one or more recommended indices from a codebook of precoding matrices.

The RI may define a recommended number of layers suitable for transmission.

A configuration that supports mTRP may increase throughput and/or reliability for downlink and/or uplink transmissions.

In an embodiment, uplink mTRP may apply to TDM-based repetition transmissions. TDM-based repetition schemes may increase reliability by exploiting channel diversity while not increasing throughput. Moreover, TDM-based transmission may limit the spectral efficiency of the mTRP based transmissions.

For example, the number of supported codewords in DL and UL may be limited to 2 and 1, respectively. In an mTRP scenario where WTRU to TRP links may show significantly different channel qualities, using the same codeword may limit the throughput. In this scenario, the same codeword may be used for different channels, and the resulting links may be assigned the same modulation and coding parameters. As a result, while channel quality may differ, the throughput of high quality links may be reduced due to an assignment of a low order modulation and coding.

The number of supported codewords may be increased to match the number of TRPs to exploit spatial diversity. A WTRU that supports multi-panels may increase the impact of spatial diversity when different data may be transmitted from different panels.

As an example, if the same data is transmitted from multiple panels, the reliability of the transmission may increase since unrecoverable transport blocks in one link may be recovered in another link.

Schemes that support multiple panels may comprise repetition and TDM-based transmissions while keeping the panel information transparent to the BS.

In addition, an increase in throughput resulting from multiple panels may be limited due to, for example, a limited number of codewords which may prevent the exploitation of spatial diversity based on panels to TRP associations. The number of supported codewords may be increased to match the number of panels, thereby realizing the spatial diversity benefits of panels to TRP associations.

There may be a need or requirement to use a single codeword for all panels to TRP links. In this scenario, the association of the same MCS index to all panels to TRP links may not be well-defined and/or trivial. As a result, in this scenario, new methods, procedures, and/or signaling may be required to support multiple panels to mTRP links.

Maximizing throughput when assigning one or more panels to mTRP may require defining multiple codewords for each link. However, using multiple codewords may bring a considerable amount of signaling overhead, including MCS index and/or CSI feedback. This signaling overhead may require new efficient methods to reduce this overhead.

Methods and procedures may be implemented to support multiple codewords for transmissions, including multiple panels and/or mTRPs. For example, different codewords per panel may be used. For example, a single codeword for all panels may be used.

In an embodiment, methods for indicating panel to TRP associations between WTRU and TRPs may be performed by covering both downlink and uplink transmissions. Additionally, methods may be implemented to reduce the overhead caused by additional CQI and/or MCS fields in the UCI and/or DCI.

In an embodiment, one or more panels may be indicated and associated with one or more TRPs. Methods may be implemented to handle a panel to TRP association and/or indications for multiple panels and TPRs.

A panel to TRP association may also apply to FR2 and higher frequencies where narrow beams may be present and/or to lower frequencies with subscriber data management (SDM).

In a WTRU to mTRP setting, where a WTRU may be equipped with multiple panels, a panel to TRP association may not be straightforward. For example, each panel may receive CSI-RS from each TRP, and the panels may be associated with and/or mapped to multiple TRPs.

In an embodiment, there may be a different CW per panel. For example, when one CW per panel is supported, each panel may be associated with one or more TRPs. For example, when one CW per panel is supported, each panel may be associated with at most one TRP.

The channel quality of panel to TRP links may be different, for example, due to different orientations of panels. In such cases, assigning each panel to a TRP with the best link quality and using all resources for the link may lead to higher throughput. Associating each panel to one TRP may ease the synchronization requirements on TRPs if a panel were to receive and/or send different layers from/to different TRPs.

The associations may depend on the number of available TRPs and panel(s). For example, the number of TRPs may define the number of potential TRPs to which the WTRU may establish a connection. The number of panels may denote the number of (all) active TRPs.

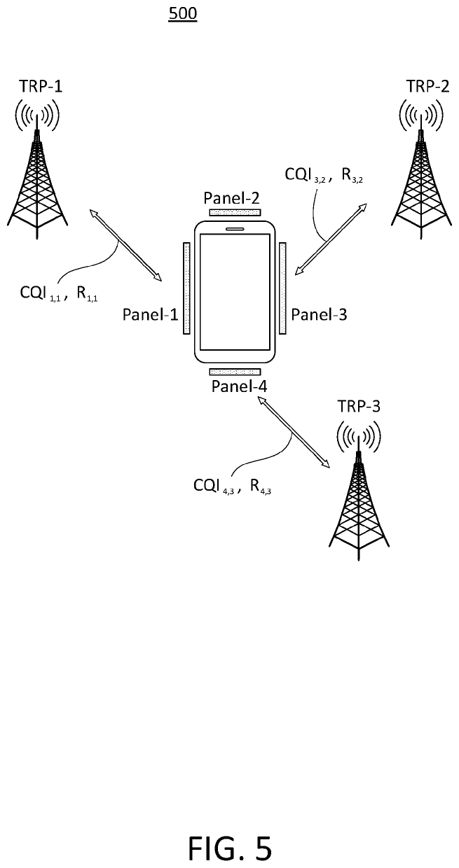

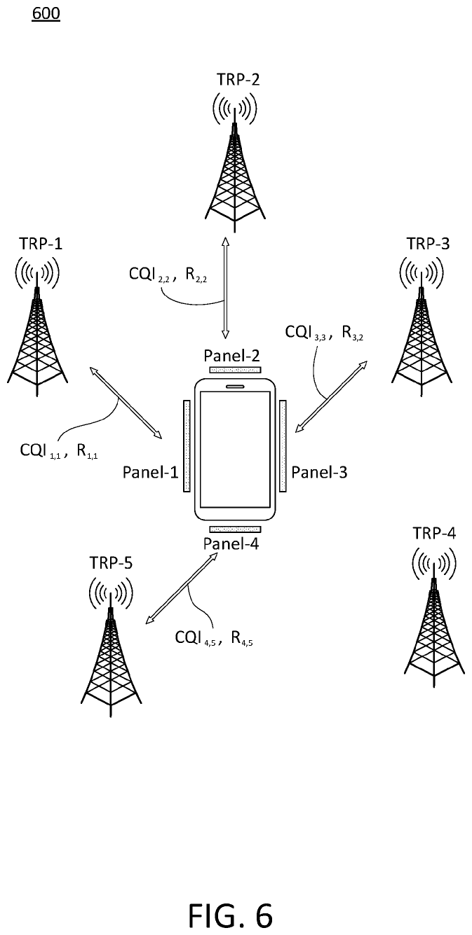

FIG. 5 is a diagram 500 illustrating an example panel to TRP association involving 4 panels and 3 TRPs. FIG. 6 is a diagram 600 illustrating an example panel to TRP association involving 4 panels and 5 TRPs.

As shown in FIG. 5, if the number of TRPs (N_{TRP}) is lower than the number of panels (N_{P}), then a subset of panels of size N_{TRP} may be used. As shown in FIG. 6, if the number of TRPs is higher than the number of panels, then a subset of TRPs of size N_{P} may be used. The methods for selecting a subset of panels and/or TRPs may be executed at the BS for UL. The methods for selecting a subset of panels and/or TRPs may be executed at the WTRU for DL.

In an embodiment, the association of panels to TRPs may be formulated as a throughput maximization function. In the example throughput maximization function shown below, x_(i,j) may be binary decision variables denoting the link from Panel-i to TRP-j. The TRPs may be distinguished using the coresetPoolIndex in DCI. The x_(i,j) variable may be equal to 1 if a link from Panel-i to TRP-j is selected and may be equal to 0 otherwise.

The throughput maximization function may ensure that the highest throughput may be selected by means of computing the sum of the product of CQI (CQI_(i,j)) and Rank (R_(i,j)) for the selected (i,j) links. For example, the constraints of the throughput maximization function may ensure that panels and TRPs are connected to at most one link and that the maximum number of links equals the minimum number of panels (N_P) and TRPs (N_TRP).

$$max {\sum }_{i , j} {x}_{i , j} \cdot {CQI}_{i , j} \cdot {R}_{i , j}$$

$${\sum }_{j} {x}_{i , j} \leq 1 \qquad ∀ i$$

$$\begin{matrix}{\sum }_{i} {x}_{i , j} \leq 1 & ∀ j\end{matrix}$$

$${\sum }_{i , j} {x}_{i , j} \leq min \{ {N}_{P} , {N}_{TRP} \}$$

In an embodiment, multiple codewords may be assigned per panel. The multiple codewords per panel may use the same modulation and coding parameters since the channel properties between a panel TRP may be the same.

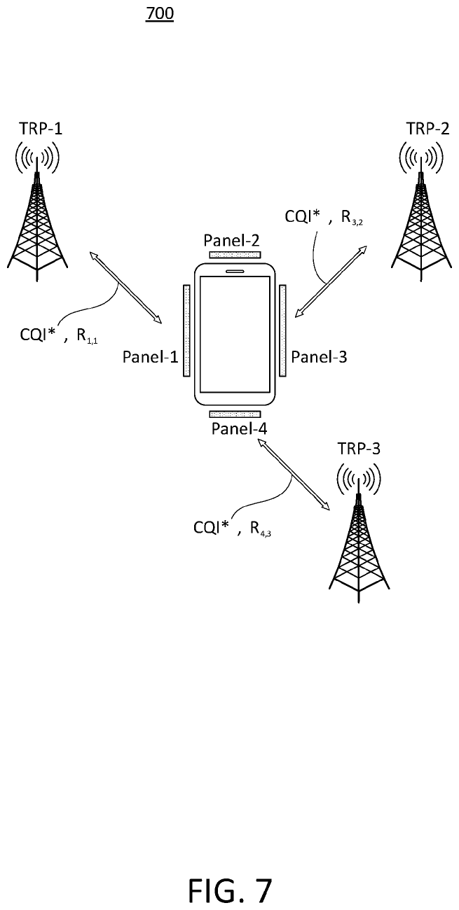

FIG. 7 is a diagram 700 illustrating an example panel to TRP associations for a single CW for 4 panels and 3 TRPs. In an embodiment, a single CW may be used for all panels. As shown in FIG. 7, when the WTRU is required to use one CW for all the panel to TRP links, all the links may be applied with the same channel protection where the same CQI may be reported for all the links. For example, using only one codework may be important for low complexity devices to save processing power. In such cases, an iterative optimization problem may be formulated to obtain the CQI that yields the highest throughput given an average block error rate (BLER). The formulated solution may be adapted to various numbers of panels and TRPs.

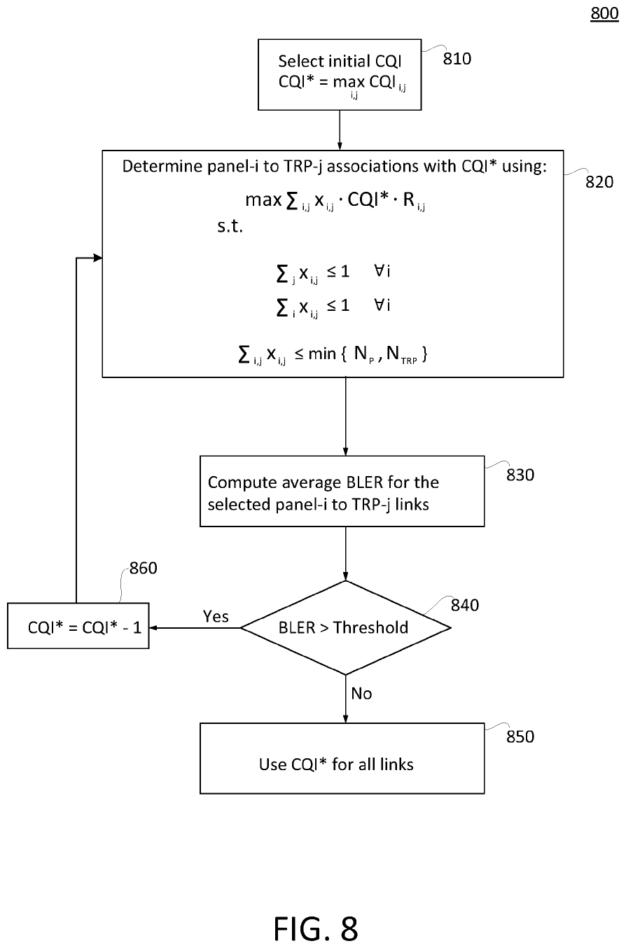

FIG. 8 is a diagram illustrating a procedure 800 for obtaining a single CQI value for a single CW for all panels. The method may be executed at the BS for UL and at the WTRU for DL. At 810, the WTRU (or BS) may select an initial CQI. For example, a CQI* variable may be set to a defined maximum CQI value for all panel to TRP links (max_{i,j} CQI_{i,j}).

At 820, the WTRU (or BS) may be configured to determine a panel to TRP association with CQI. For example, the maximum objective function may be implemented using the CQI* variable for all panel to TRP links. At 830, the WTRU (or BS) may determine (e.g., calculate) an average BLER for all the panel to TRP links, for example, as previously determined by the maximum objective function.

At 840, the WTRU (or BS) may determine whether the calculated average BLER is greater than a defined threshold. If the WTRU (or BS) determines that the calculated average BLER is not greater than the threshold at 840, the WTRU (or BS) may apply the CQI* variable to all panel to TRP links at 850. If the WTRU (or BS) determines that the calculated average BLER is greater than the threshold at 840, the WTRU (or BS) may reduce the CQI* variable by a defined amount. As an example, the CQI* variable may be reduced by a value of 1. If the WTRU (or BS) determines that the calculated average BLER is greater than the threshold at 840, the procedure may return to 820. For example, the maximum objective function may be iteratively re-implemented using the reduced CQI* variable for all panel to TRP links.

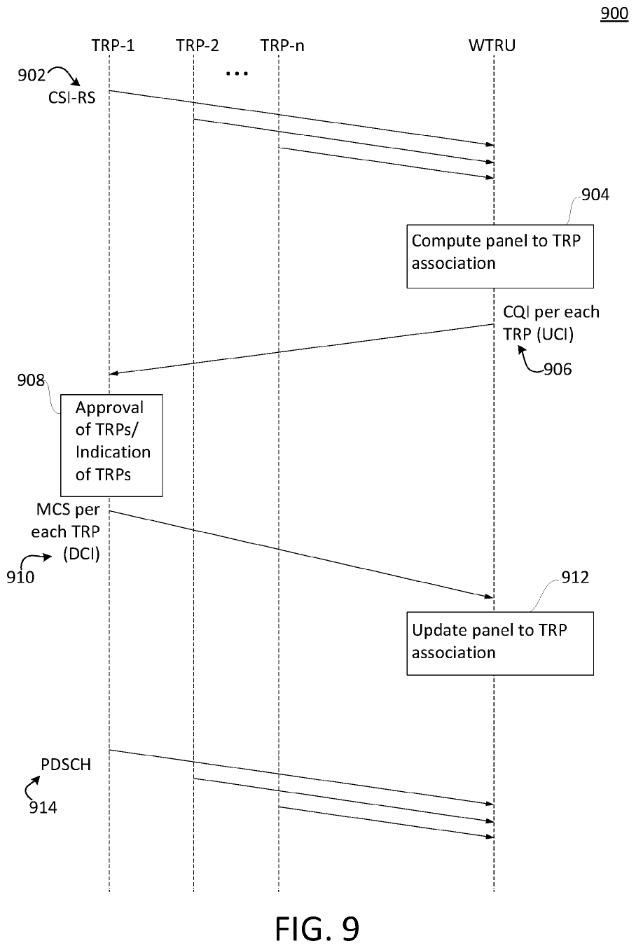

FIG. 9 is a diagram illustrating an example procedure 900 performed by a WTRU and one or more TRPs. The example procedure 900 may be applied to downlink PDSCH. The WTRU may share capability information with a BS regarding its multi-panels and mTRP capability. The BS may then configure the WTRU to use these multi-panels and mTRP capabilities.

In a panel to TRP association for DL, the BS (e.g., TRPs) may not need to be aware of the panels. As shown in FIG. 9, a TRP-1 may be a (e.g., master) BS, where the control channel may be transmitted. At 902, the TRP-1 (e.g., BS) may send the control information regarding the CSI-RS from each TRP to WTRU link. The WTRU may receive the CSI-RS from each panel and compute CSI (e.g., CQI and RI) for each TRP to panel link. The WTRU may then compute panel to TRP associations at 904. The WTRU may report the best CQI for each TRP in the UCI at 906. For example, this solution may require CSI fields (e.g., CQI and RI) for each TRP in the UCI.

In some examples, the WTRU may not report panel level CSI. If the WTRU does not report panel level CSI, the WTRU panels may be transparent to the BS (902). For example, the BS may receive CSI feedback from the WTRU and may check the availability of resources in the TRPs.

The BS may either approve of the TRPs indicated by the WTRU, or the BS may indicate a subset of TRPs to the WTRU at 908. In either case, the BS may send an MCS index for each of the TRPs to the WTRU in a DCI at 910.

In some examples, a coresetPoolIndex parameter may be utilized. For example, the new fields in the DCI may be the number of TRPs, MCS index per all TRPs, and/or corresponding TRP index (e.g., coresetPoolIndex). This configuration may be an example of explicit signaling associated with DCI regarding multi-panel mTRP.

The WTRU may receive a DCI that includes MCS per TRP information. In this configuration, once the WTRU receives the DCI that includes MCS per TRP information, the WTRU may update the association between the panel and TRP at 912.

The indicated TRPs may be the same as the ones indicated by the WTRU (e.g., at 906). If the TRPs indicated by the BS are the same as the ones indicated by WTRU, no update may be necessary.

The TRP indices indicated by the BS may be a subset of the ones indicated by the WTRU. If the TRP indices indicated by the BS are a subset of the ones indicated by the WTRU, the WTRU may update the panel to TRP associations and may include the ones indicated by the BS. As an example, if the TRP indices indicated by the BS are a subset of the ones indicated by the WTRU, the WTRU may update the panel to TRP associations by including only the ones indicated by the BS. Following this update, the WTRU may receive PDSCH via the panels associated with the TRPs at 914.

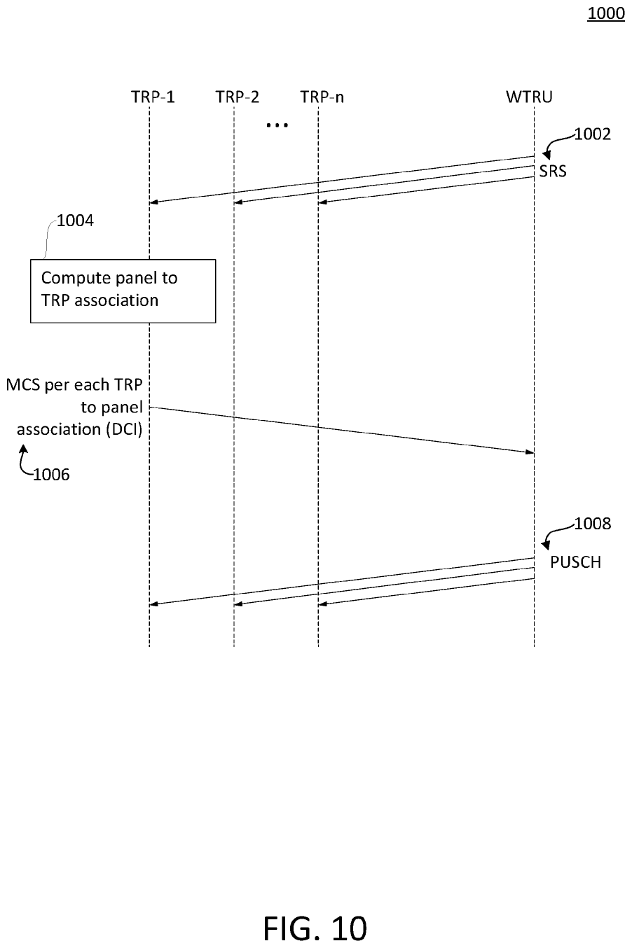

FIG. 10 is a diagram illustrating an example procedure 1000 performed by a WTRU and one or more TRPs. The example procedure 1000 may be applied to uplink PUSCH. Prior to determining and/or establishing any association, the WTRU may share capability information with the BS regarding multi-panels and mTRP capability. The BS may configure the WTRU to use these capabilities.

If a panel to TRP association for UL is indicated, the BS (e.g., TRPs) may need to be aware of the panels. As shown in FIG. 10, a TRP-1 may be a (e.g., master) BS, where the control channel may be transmitted. At 1002, the WTRU may send SRS from each panel to all TRPs. If TRP-1 is the (e.g., master) BS, where the control channel is transmitted, the WTRU may send SRS from each panel to all TRPs. In response to the transmitted SRS, the BS may receive one or more reference signals from all panels to all TRPs. The BS may compute the channel quality between all panels and TRPs after receiving a reference signal from all panels to all TRPs. Based on the computed channel quality, the BS may compute the panel to TRP associations at 1004. The BS may then send MCS for each TRP to panel association in DCI at 1006. Additional MCS fields for each TRP may be required, which may, for example, include TRP and/or panel indices for each MCS. This DCI configuration may be an example of explicit signaling associated with DCI regarding multi-panel mTRP. The WTRU may receive the DCI with MCS information and may prepare for PUSCH transmission accordingly at 1008.

In an embodiment. CQI/MCS bitwidth reduction may be performed. Bitwidth reduction methods may be carried out to handle increases in MCS information in multiple codeword scenarios.

In the single DCI mode of operation with multi-panel transmission in DL, CQI for each panel may be sent within the UCI transmitted from a WTRU to a BS. In the single DCI mode of operation with multi-panel transmission in DL, CQI for each WTRU panel must be sent within the UCI from the WTRU to the BS. In multi-panel transmission in UL, MCS for each panel may be sent within the DCI from the BS to the WTRU. As an example, for multi-panel transmission in UL, MCS for each panel may be sent within the DCI from the BS to the WTRU. The required CQI/MCS indication bitwidth may be increased linearly with the number of CWs. For example, sending CQI/MCS for each codeword may require 4/5 bits per codeword within the UCI/DCI.

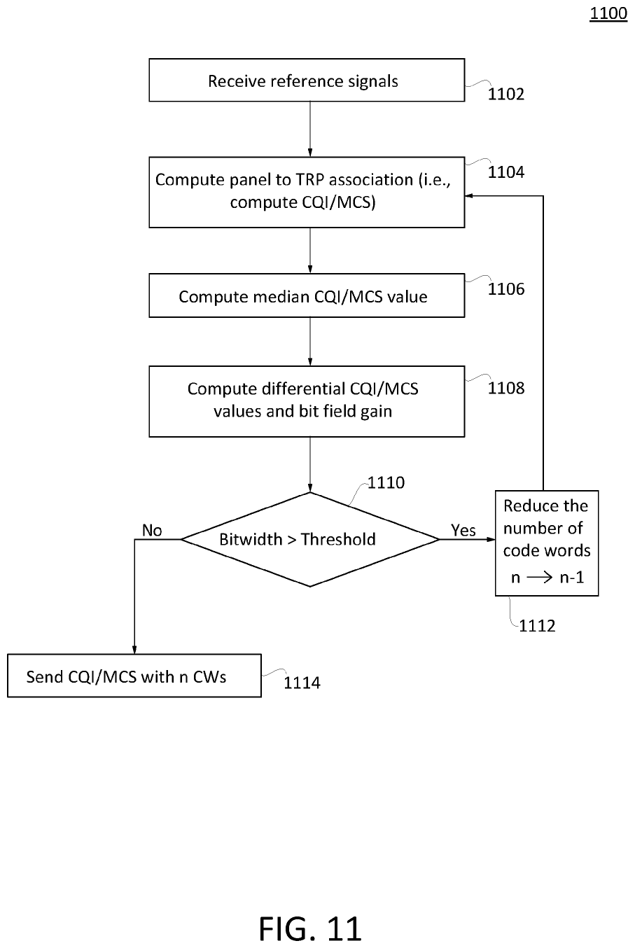

FIG. 11 is a flowchart illustrating an example procedure 1100 for bitwidth reduction based on computed CQI/MCS values. The procedure 1100 may be implemented to determine a CQI for a single CW for all panels. The procedure 1100 may be implemented in the WTRU and/or the BS. Whether the example process 1100 is implemented in the WTRU or the BS may depend on whether the process occurs during DL or UL transmission.

As shown in FIG. 11, during DL transmission, the WTRU may receive CSI-RS from each TRP to each panel at 1102. Once the CSI-RS signals are received, the WTRU may compute a panel to TRP association at 1104. For example, the WTRU may compute a CQI for each panel to TRP link. The WTRU may first receive CSI-RS from each TRP to each panel during a DL transmission. The WTRU may then compute a panel to TRP association. The WTRU may also compute CQI for each panel to TRP link. Additionally, among the computed CQIs, a CQI value may be determined to compute differential CQIs.

The WTRU may compute a median of CQIs at 1106. The WTRU may compute differential CQI values of each CQI to the median CQI at 1108. The bitwidth of differential CQI values may be less than or equal to the bitwidth of actual CQI values. Moreover, in some examples, the bitwidth of differential CQI values may always be less than or equal to the bitwidth of actual CQI values. The WTRU may compute the total bitwidth of the median CQI and all differential CQIs.

At 1110, the WTRU may determine if the total bitwidth is greater than a predetermined threshold. If the WTRU determines that the total bitwidth is above the predefined threshold at 1110, the WTRU may reduce the number of codewords at 1112, and the WTRU may return to 1104. For example, if the WTRU determines that the total bitwidth is above the predefined threshold at 1110, the WTRU may reduce the number of codewords at 1112 and may iteratively re-compute the panel to TRP association using the reduced number of codewords. If the WTRU determines that the bitwidth is lower than the threshold at 1110, the WTRU may send the median CQI and accompanying differential CQIs with TRP and/or panel indicators at 1114.

Concerning CQI transmissions, the related UCI fields may first include the median CQI and the corresponding TRP index. These UCI fields may be followed by a differential CQI of the following TRP to panel links and TRP indices.

Concerning MCS transmissions, the related DCI fields may first include the median MCS, corresponding TRP, and panel indices. These fields may be followed by differential MCS of the following TRP to panel links, TRP, and panel indices.

In an embodiment, priority-aware CS/panel to TRP association may be performed. Different data streams (e.g., logical channels) may relate to different use-cases and priorities. Each of the different data streams may be applied to different code rates and/or modulations, which themselves may depend on the type/priority of the stream. As an example, the priorities may be related to the QoS of the data and/or the traffic class.

Applications may be run on the WTRU side, and DL/UL priorities may depend on the applications/streams that the WTRU may demand. The panel to TRP association methods may be based on priorities. If data stream priorities are available for use at the BS and/or WTRU PHY and/or MAC layer, the panel to TRP association methods may be based on the priorities. For example, the availability of priority information at MAC/PHY layer may be achieved with a cross-layer block that may carry information between different protocol stack layers.

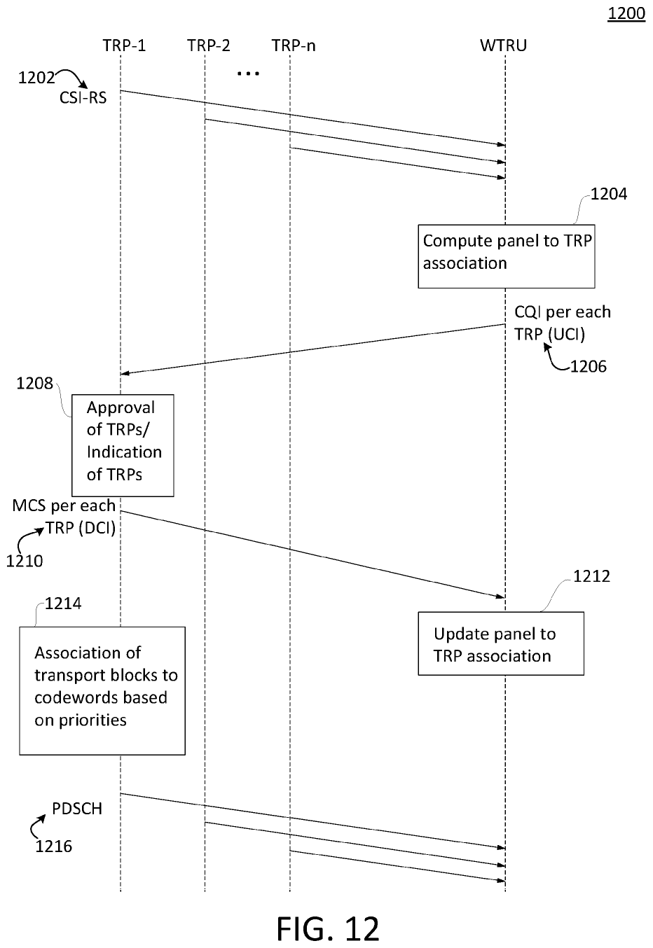

FIG. 12 is a diagram illustrating an example procedure 1200 performed by a WTRU and one or more TRPs for associating panel(s) to TRP(s) for a DL channel based on priorities. The procedure disclosed in FIG. 12 may be similar to that disclosed in FIG. 9 for a panel to TRP association for DL with the addition of modifications performed to PDSCH data prior to transmission. In the procedure 1200, prior to starting PDSCH, an additional procedure may be performed to associate transport blocks (or logical channels) with codewords. This association may be based on the priorities for transport blocks (or logical channels).

A TRP-1 may be a (e.g., master) BS, where the control channel may be transmitted. The TRP-1 (e.g., BS) may send the control information regarding the CSI-RS from each TRP to WTRU link at 1202. The WTRU may receive the CSI-RS from each panel and compute CSI (e.g., CQI and RI) for each TRP to panel link. The WTRU may then compute panel to TRP associations at 1204. The WTRU may report the best CQI for each TRP in the UCI at 1206. For example, this solution may require CSI fields (e.g., CQI and RI) for each TRP in the UCI.

The BS may either approve of the TRPs indicated by the WTRU, or the BS may indicate a subset of TRPs to the WTRU at 1208. In either case, the BS may send an MCS index for each of the TRPs to the WTRU in a DCI at 1210.

Once the WTRU receives the DCI that includes MCS per TRP information, the WTRU may update the association between the panel and TRP at 1212. The TRP-1 may associate transport blocks (or logical channels) with codewords at 1214. This association may be based on the priorities for transport blocks (or logical channels). Following the transport blocks to codewords association, the WTRU (1208) may receive a PDSCH transmission via the panels associated with the TRPs at 1216.

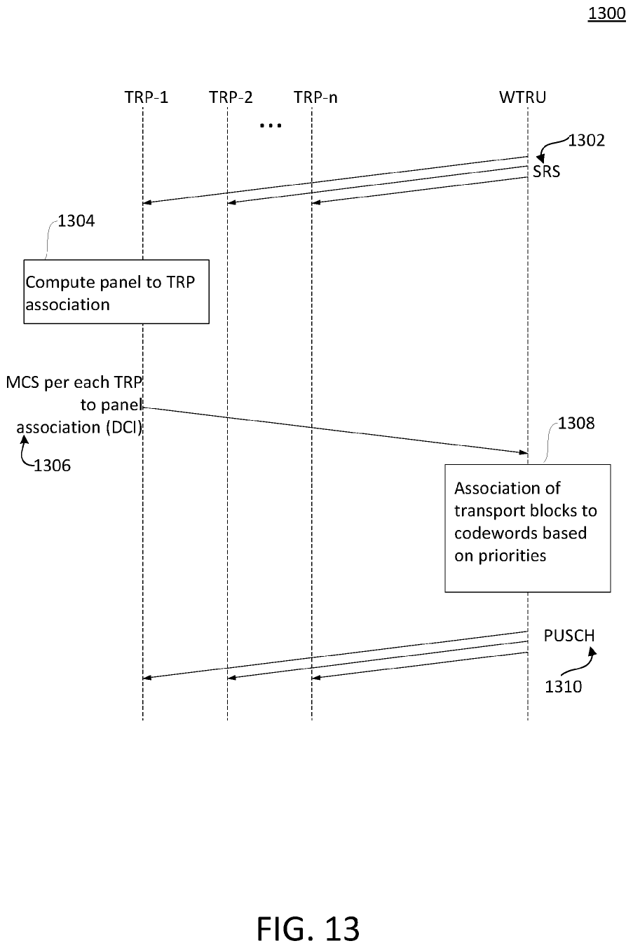

FIG. 13 is a diagram illustrating an example procedure 1300 performed by a WTRU and one or more TRPs for associating panel(s) to TRP(s) for UL based on priorities. The procedure disclosed in FIG. 13 may be similar to that disclosed in FIG. 10 for a panel to TRP association for UL with the addition of modifications performed to PUSCH data prior to transmission. In the procedure 1300, prior to starting PUSCH, an additional procedure may be performed to associate transport blocks (or logical channels) with codewords. This association may be based on the priorities for transport blocks (or logical channels).

A WTRU may send SRS from each panel to all TRPs at 1302. If TRP-1 is the (e.g., master) BS, where the control channel is transmitted, the WTRU may send SRS from each panel to all TRPs. In response to the transmitted SRS, the BS may receive one or more reference signals from all panels to all TRPs. The BS may compute the channel quality between all panels and TRPs after receiving a reference signal from all panels to all TRPs. Based on the computed channel quality, the BS may compute the panel to TRP associations at 1304. The BS may then send MCS for each TRP to panel association in DCI at 1306. Additional MCS fields for each TRP may be required, which may, for example, include TRP and/or panel indices for each MCS. This DCI configuration may be an example of explicit signaling associated with DCI regarding multi-panel mTRP. The WTRU may receive the DCI with MCS information. After receiving the DCI, the WTRU may associate transport blocks (or logical channels) with codewords at 1308. This association may be based on the priorities for transport blocks (or logical channels). Following the transport blocks to codewords association, the WTRU may prepare for a PUSCH transmission accordingly at 1310.

The association of transport blocks (TB) (or logical channels) to codewords for both UL and DL may be performed based on a ranking of priorities in a descending order. For example, the highest priority may be assigned to a channel with the highest quality based on having the highest MCS. If the priorities are the same, then no operation may be performed in that block.

In an embodiment, different CWs, and potentially the associated CSI/MCS, may be associated with different QoS targets (e.g., different target BLER, latency, etc.).

In an embodiment, the block for the association transport blocks (or logical channels) to codewords (e.g., based on priorities) may be an additional new block between DL-SCH/UL-SCH and PDSCH/PUSCH prior to the start of PDSCH/PUSCH processing.

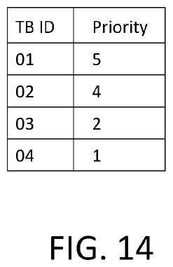

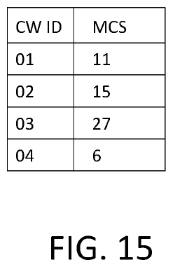

FIG. 14 is a table illustrating examples of TB priorities. FIG. 15 is a table illustrating examples of CW MCS indices. FIG. 14 and FIG. 15 may disclose exemplary priorities of TBs and MCS indices of CWs.

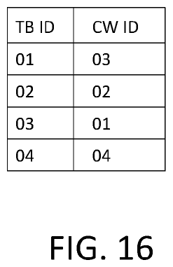

FIG. 16 is a table illustrating examples of TB to CW associations. FIG. 16 may disclose exemplary associations of TBs to CWs based on FIG. 14 and FIG. 15.

In an embodiment, a WTRU may perform panel to TRP associations. The WTRU may receive DL reference signals for channel quality measurement from each TRP to each panel. The WTRU may compute the panel to TRP associations. If one CW is allowed per panel, the WTRU may compute an optimization to solve for the optimal panel to TRP associations, given the link quality of all panel to TRP links.

If only one CW for all panels is allowed, the WTRU may compute an iterative optimization to find the best CQI value for all CW to TRP links to satisfy a BLER constraint or any other relevant constraint. The WTRU may send the CQI for each requested TRP to BS association. If CQI bitwidth reduction is to be used, the WTRU may use a CQI bitwidth reduction mechanism to send the CQI per TRP in the UCI. The WTRU may receive approval for its requested TRP and/or an indication of new MCS to TRP associations. In an embodiment, the WTRU may update the panel to TRP associations. If priority aware CW to TRP association is used, the BS may perform TB to CW association before the WTRU receives the PDSCH. The WTRU may then start to receive PDSCH.

In an embodiment, a BS may perform panel to TRP associations. The WTRU may send UL reference signals for channel quality measurement to the BS from each panel to each TRP. The BS may compute the panel to TRP associations. If only one CW per panel is allowed, the BS may compute an optimization to solve for the optimal panel to TRP association, given the link quality of all panel to TRP links.

If only one CW for all panels is allowed, the WTRU may compute an iterative optimization to find the best CQI value for all CW to TRP links to satisfy a BLER constraint. The WTRU may receive an MCS index for each TRP (e.g., together with panel indicators). If MCS bitwidth reduction is used, the BS may use an MCS bitwidth reduction mechanism to send the MCS per TRP in the DCI. If priority aware CW to TRP association is used, the WTRU may perform a TB to CW association before WTRU sends the PUSCH. The WTRU may then start to send PUSCH.

The present disclosure provides methods and procedures for a multi-panel WTRU with mTRP access capability to receive retransmissions of TBs (e.g., codewords) with different priorities over different panels and/or TRPs than originally scheduled. The WTRU may determine the best panel to TRP links according to the CSI-RS measurements. The WTRU may then report CSI for top-K TRPs per panel to the NW. In case of a decoder failure on one of the TBs received in panels, the WTRU may apply the configured procedures to process the retransmission.

A WTRU capable of multi-panel to mTRP associations may comprise one or more features. The WTRU may be configured with rules for determining which panel to use for retransmissions in case of a decoding failure. The WTRU may be configured to use the next best panel to TRP link to receive retransmissions of the packet. The WTRU may stop processing through the panel with decoding failure and continue to receive DL data from all other panels. This first configuration may provide for a DCI free retransmission.

The WTRU may be configured to receive retransmission from another TRP to the corresponding panel when a decoding failure occurs. The association of the new TRP may be determined according to the previous CSI report. For example, a new DCI may be defined to allocate new resources to the panel from the new TRP (e.g., the next best TRP that the panel reported). This configuration of rules may require the retransmission of DCI.

WTRU may be configured to omit ACK/NACK messages for low priority codewords.

The WTRU may be configured with a number of CSI reports per panel, K. The WTRU may report CSI corresponding top-K TRPs, in terms of L1-RSRP.

The WTRU may receive and process CSI-RS and may compute CSI feedback per panel. In computing CSI feedback per panel, the WTRU may receive CSI-RS from each TRP to each panel and may compute CQI/PMI for each TRP to panel channel measurement. The WTRU may then determine the K TRPs for each panel that gives top-K CQI values. The WTRU may then generate K CSI feedback for each panel (e.g., per panel-ID), including TRP-ID, CQI, and PMI. The total number of CSI feedback becomes Nₚ K, where Nₚ denotes the number of panels. The WTRU may feedback Nₚ K CSI feedback messages to the NW accordingly.

The WTRU may receive Semi Persistent Scheduling (SPS) on TRP to panel associations. The WTRU may receive SPS that configures each TRP to panel link. The SPS may provide information to the WTRU on the associated TRPs to each panel, the priority of a TRP to panel association, MCS per TRP to panel association, and corresponding resource per TRP to panel association. The WTRU may receive scheduling information for each panel-ID, including TRP-ID, MCS, and resources.

The WTRU may receive DCI to activate CS. The WTRU may start receiving DL data simultaneously on each panel with different priorities.

The WTRU may detect a decoding failure on a TB. If the decoding failure is detected on a codeword with the highest priority, the WTRU may feedback NACK to NW and may determine which panel to use for retransmissions.

The WTRU may determine which panel to use for retransmissions based on a configuration of rules. For example, as described above, the WRU may stop processing the DL data from the panel that receives the highest priority TB. The WTRU may receive the retransmission of the packet from another panel with the next best CQI using the same resource allocations indicated by SPS.

The WTRU may receive in DCI an indication on the new TRP resources for the highest priority panel with decoding failure. After receiving the DCI, the WTRU may receive DL data on the panel from another TRP using the resources indicated in the DCI. The WTRU may have already reported CSI for top-K TRPs for the panel.

If a decoding failure is detected on a codeword with a lower priority, the WTRU may omit sending NACK according to a configuration to prevent retransmission on low priority TBs.

The WTRU may be triggered to update TRP to panel associations. The NW may indicate to the WTRU to update TRP to panel associations. The WTRU may then feedback new CSI reports per panel and may receive new TRP to panel associations. After sending a NACK on the highest priority packet, the WTRU may receive CSI-RS and updates to the TRP to panel associations. The WTRU may then feedback new CSI reports per panel and receive new TRP to panel associations.

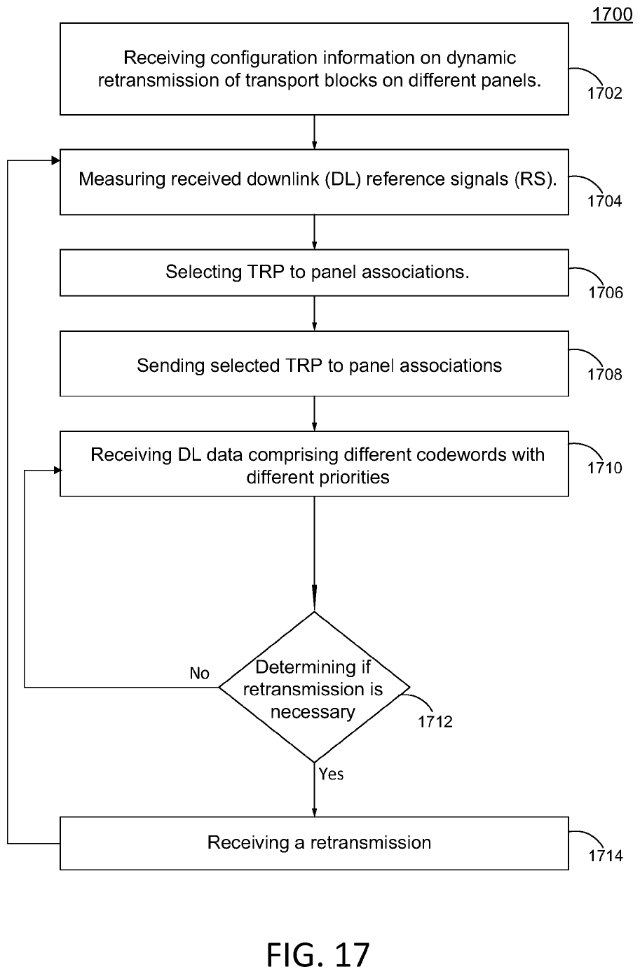

FIG. 17 is a flowchart illustrating an example procedure 1700 for retransmission on different panels. A WTRU may perform the procedure 1700, for example, in response to receiving configuration rules from the network. At 1702, the WTRU may receive configuration information on dynamic retransmission of transport blocks on different panels. For example, the WTRU may receive configuration information indicating one or more rules for determining a panel out of a plurality of panels that is to be used for reception of a retransmitted codeword.

At 1704, the WTRU may measure received DL reference signals (RS). For example, the WTRU may measure DL RSs sent from each of a plurality of TRPs. A respective DL RS is received from each of the plurality of TRPs via a panel of the plurality of panels.

At 1706, the WTRU may select TRP to panel associations. For example, the WTRU may select a respective TRP to each of the plurality of panels based on the measured DL RSs.

At 1708, the WTRU may send selected TRP to panel associations. For example, the WTRU may send feedback indicating the respective TRP selected for each of the plurality of panels. A channel quality (CQI) feedback may be provided for each combination of the plurality of TRPs and the plurality of panels.

At 1710, the WTRU may receive DL data comprising different codewords with different priorities. For example, the WTRU may receive at least a first codeword from a first TRP of the plurality of TRPs via a first panel of the plurality of panels and a second codeword from a second TRP of the plurality of TRPs via a second panel of the plurality of panels.

At 1712, the WTRU may determine if a retransmission is necessary. For example, the WTRU may determine that a retransmission of the first codeword from the first TRP is to be received via the second panel based on the first codeword being higher priority than the second codeword. The determination may be based on the one or more rules indicated by the configuration information.

If it is determined that a retransmission is necessary, at 1714, the WTRU may receive a retransmission. For example, the WTRU may receive the retransmission of the first codeword from the first TRP via the second panel. Once a retransmission is received, the WTRU may iteratively receive downlink (DL) reference signals (RS) at 1704.

If it is determined that a retransmission is not necessary, the WTRU may continue to receive DL data comprising different codewords with different priorities at 1710.

The processes described above may be implemented in a computer program, software, and/or firmware incorporated in a computer-readable medium for execution by a computer and/or processor. Examples of computer-readable media include but are not limited to, electronic signals (transmitted over wired and/or wireless connections) and/or computer-readable storage media. Examples of computer-readable storage media include but are not limited to, a read-only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

What is claimed is:

1-20. (canceled)

21. A method performed by a wireless transmit/receive unit (WTRU), the method comprising:
receiving configuration information indicating one or more rules for determining a panel out of a plurality of panels that is to be used for reception of a retransmitted codeword;
measuring downlink (DL) reference signals (RSs) sent from each of a plurality of transmission/reception points (TRPs), wherein a respective DL RS is received from each of the plurality of TRPs via a panel of the plurality of panels;
selecting a respective TRP for each of the plurality of panels based on the measured DL RSs;
sending feedback indicating the respective TRP selected for each of the plurality of panels, wherein channel quality indication (CQI) feedback is provided for each combination of the plurality of TRPs and the plurality of panels; and
receiving at least a first codeword from a first TRP of the plurality of TRPs via a first panel of the plurality of panels and a second codeword from a second TRP of the plurality of TRPs via a second panel of the plurality of panels.

22. The method of claim 21, further comprising:
determining that a retransmission of the first codeword from the first TRP is to be received via the second panel based on the first codeword being higher priority than the second codeword and based on the one or more rules indicated by the configuration information; and
receiving the retransmission of the first codeword from the first TRP via the second panel.

23. The method of claim 21, further comprising:
receiving information indicating an association between each of the plurality of TRPs and each of the plurality of panels, a priority of each TRP to panel association, a modulation and coding scheme (MCS) for each TRP to panel association, or a resource to be used for each TRP to panel association.

24. The method of claim 21, wherein the one or more rules indicates:
whether the WTRU is configured for downlink control information (DCI)-free retransmission or retransmission with DCI;
whether or not the WTRU should transmit acknowledgement (ACK) messages for received codewords; or
a number of CQI reports that are configured per panel of the plurality of panels.

25. The method of claim 21, wherein the feedback indicates that a CQI associated with a combination of the first TRP and the first panel is stronger than any other combination of the plurality of TRPs and the plurality of panels.

26. The method of claim 21, further comprising:
determining that the retransmission of the first codeword is to be received from the first TRP via the second panel based on a CQI associated with the combination of the second TRP and the second panel being stronger than any other combination of the plurality of TRPs and the plurality of panels except for a combination of the first TRP and the first panel.

27. The method of claim 21, further comprising:
receiving an indication that the retransmission of the first codeword is to be received from the first TRP via the second panel.

28. The method of claim 21, further comprising:
detecting that a failure occurred when attempting to receive the first codeword from the first TRP via the first panel; and
sending a negative acknowledgement (NACK) in response to the failure prior to the determination that the retransmission of the first codeword from the first TRP is to be received via the second panel.

29. The method of claim 21, further comprising:
detecting that a failure occurred when attempting to receive the first codeword from the first TRP via the first panel;
sending an updated CQI feedback for each combination of the plurality of TRPs and the plurality of panels; and
receiving information indicating an updated association between each of the plurality of TRPs and each of the plurality of panels.

30. The method of claim 21, further comprising:
determining that the CQI feedback provided for each TRP and associated panel satisfies a block error rate (BLER) threshold.

31. A wireless transmit/receive unit (WTRU) comprising:
a processor configured to:
receive configuration information indicating one or more rules for determining a panel out of a plurality of panels that is to be used for reception of a retransmitted codeword;
measure downlink (DL) reference signals (RSs) sent from each of a plurality of transmission/reception points (TRPs), wherein a respective DL RSs is received from each of the plurality of TRPs via a panel of the plurality of panels;
select a respective TRP for each of the plurality of panels based on the measured DL RSs;
send feedback indicating the respective TRP selected for each of the plurality of panels, wherein channel quality indication (CQI) feedback is provided for each combination of the plurality of TRPs and the plurality of panels; and
receive at least a first codeword from a first TRP of the plurality of TRPs via a first panel of the plurality of panels and a second codeword from a second TRP of the plurality of TRPs via a second panel of the plurality of panels.

32. The WTRU of claim 31, wherein the processor is further configured to:
determine that a retransmission of the first codeword from the first TRP is to be received via the second panel based on the first codeword being higher priority than the second codeword and based on the one or more rules indicated by the configuration information; and
receive the retransmission of the first codeword from the first TRP via the second panel.

33. The WTRU of claim 31, wherein the processor is further configured to:
receive information indicating an association between each of the plurality of TRPs and each of the plurality of panels, a priority of each TRP to panel association, a modulation and coding scheme (MCS) for each TRP to panel association,
or a resource to be used for each TRP to panel association.

34. The WTRU of claim 31, wherein the one or more rules indicates:
whether the WTRU is configured for downlink control information (DCI)-free retransmission or retransmission with DCI;
whether or not the WTRU should transmit acknowledgement (ACK) messages for received codewords; or,
a number of CQI reports that are configured per panel of the plurality of panels.

35. The WTRU of claim 31, wherein the feedback indicates that a CQI associated with a combination of the first TRP and the first panel is stronger than any other combination of the plurality of TRPs and the plurality of panels.

36. The WTRU of claim 31, wherein the processor is further configured to:
determine that the retransmission of the first codeword is to be received from the first TRP via the second panel based on a CQI associated with the combination of the second TRP and the second panel being stronger than any other combination of the plurality of TRPs and the plurality of panels except for a combination of the first TRP and the first panel.

37. The WTRU of claim 31, wherein the processor is further configured to:
review an indication that the retransmission of the first codeword is to be received from the first TRP via the second panel.

38. The WTRU of claim 31, wherein the processor is further configured to:
detect that a failure occurred when attempting to receive the first codeword from the first TRP via the first panel; and
send a negative acknowledgment (NACK) in response to the failure prior to the determination that the retransmission of the first codeword from the first TRP is to be received via the second panel.

39. The WTRU of claim 31, wherein the processor is further configured to:
detect that a failure occurred when attempting to receive the first codeword from the first TRP via the first panel;
send an updated CQI feedback for each combination of the plurality of TRPs and the plurality of panels; and
receive information indicating an updated association between each of the plurality of TRPs and each of the plurality of panels.

40. The WTRU of claim 31, wherein the processor is further configured to:
determine that the CQI feedback provided for each TRP and associated panel satisfies a block error rate (BLER) threshold.
